(19) United States
(12) Patent Application Publication
(10) Pub. No.: US 2023/0035797 A1
(43) Pub. Date: Feb. 2, 2023

(54) Connector Comprising An Optical Interface

(71) Applicant: Conextivity Group SA, Saint-Prex (CH)

(72) Inventors: François Rey, Lausanne (CH); Xavier Greppin, Crissier (CH); Antoine Gardiol, Chavornay (CH); Thierry Goldhorn, Gland (CH)

(21) Appl. No.: 17/777,087

(22) PCT Filed: Dec. 17, 2020
(86) PCT No.: PCT/IB2020/062101

§ 371 Date: May 16, 2022

(30) Foreign Application Priority Data
Dec. 18, 2019 (IB) PCT/IB2019/061005

(51) Int. Cl. G02B 6/38

(52) U.S. Cl. CPC G02B 6/3825

(57) ABSTRACT

The invention relates to a disconnectable connector portion for forming a socket or a plug of the connector, said connector allowing relative rotation between the socket and the plug once they are connected, said portion comprising at least optical means for contactless optical transmission in the connector, said optical means being insensitive to the relative rotation.

### CORRESPONDING APPLICATION

The present application claims the priority of the previous international application number PCT/IB2019/061005 filed on 18 Dec. 2019 in the name of FISCHER CONNECTORS HOLDING SA, with the content of this previous application being fully incorporated in the present application for reference purposes.

### TECHNICAL FIELD

The present invention relates to connectors, in particular multipolar electrical connectors, that are used, for example, in the field of electrical wiring. The relevant connectors are used for/in fields requiring both reliability and flexibility, such as wearable type applications, for example, the garments or equipment of individuals moving in difficult environments (workers, emergency services, soldiers and security forces, patients, etc.) or any other similar use.

International publication WO 2017/072620 describes an example of such a multipolar connector. The connector comprises a substantially cylindrical socket and a plug, which can be detachably connected to the socket and in which a plurality of contacts is disposed. The socket comprises a disk-shaped conductive face, on or in which at least one conductive track is disposed that forms at least one arc of a circle, the center of which substantially coincides with the center of the conductive face, the track also being disposed so as to allow mechanical electrical coupling with one of said contacts. The socket and the plug form the two main components that form the connector. This connector allows easy connection between the two components and also a 360° relative rotation of the portions forming the connector (i.e., the socket and the plug).

However, the electric interface as produced in the prior art has intrinsic limitations when transferring high speed signals. For example, the path of the electrical signal has a variable length, which is a result of the angular position of the plug relative to the socket and for this reason limits the maximum transferable speeds.

Thus, an aim of the present invention is to propose solutions for improving the known devices.

More specifically, an aim of the present invention is to increase the data transmission speed of a pair of connectors, while maintaining the essential performance capabilities, which in particular are the ergonomics, the ease of connection and the cleanability, with these features being the main attributes of the products described in the prior art, such as that described above.

Another aim of the present invention is to propose a construction that allows a high data transmission speed, of the order of 10 Gbit/s or more, and/or at least USB 3.0 (also called SuperSpeed USB, SuperSpeed USB 10 Gbps and SuperSpeed USB 20 Gbps) or more and other values of this order of magnitude.

### DEFINITIONS

TOSA: “Transmitter optical sub-assembly”. A transmitter optical sub-assembly integrating a laser diode, a monitoring photodiode, an optical interface, a plastic or metal casing and an electrical interface.

ROSA: “Receiver optical sub-assembly”. A receiver optical sub-assembly integrating a photodiode, an optical interface, a plastic or metal casing and an electrical interface. It can also integrate an electrical amplifier and dichroic filters.

BOSA: “Bi-Directional optical sub-assembly”. A bi-directional optical sub-assembly integrating a ROSA and a TOSA in the same casing with a single optical interface and wavelength multiplexing (WDM). The received signal does not have the same wavelength as the transmitted signal.

### SUMMARY OF THE INVENTION

A basic idea of the present invention is to replace the electrical interface on the plug and the circular rings on the socket (or vice versa), as known from WO 2017/072620, with an optical interface, or at least to add an optical interface to the electrical contacts that are present.

Replacing a physical electrical interface with a contactless optical interface, or by adding such a contactless optical interface to a construction comprising a physical electrical interface, particularly overcomes the limitations of the prior art as described above.

Furthermore, having an ultra-high speed optical line allows high transmission speeds of the order of the aforementioned speed values and a very high number of different signals to be achieved. This therefore also means that the density of contacts can be increased in a given and unchanged footprint. The solution proposed by the present invention therefore forms a very interesting alternative that avoids increasing the size of the connectors in order to add contacts, as well as providing the performance capabilities resulting from the ultra-high speed optical line.

One of the challenges of the present invention is to maintain the 360° rotation property once the plug and the socket are connected without affecting the quality of the optical transmission.

An optical beam transmission mechanism (bi-directional) that is insensitive to rotation has thus been developed and forms part of the present invention.

Throughout the remainder of the description, by definition, the notion of “connector” is considered to cover a socket and a plug that are connected together.

The considered constraints that have been taken into account are as follows:
the connector must be able to rotate on itself, i.e., the socket and the plug can have a relative rotation of 360°;
the electrical signals must not be disrupted by this rotation.

The invention will be better understood from the description of illustrative embodiments and from the drawings accompanying this description.

According to embodiments, the invention relates to a disconnectable connector portion intended to form a socket or a plug of the connector, the connector allowing relative rotation between the socket and the plug about an axis of rotation of the connector once these portions are connected. The connector portion comprises at least optical means for contactless optical transmission in the connector, said optical means being insensitive to the relative rotation and comprising at least one laser intended to emit a beam and a photodiode intended to receive a beam, with one of the optical means being on one side of said axis of rotation.

In embodiments, the optical means are preferably on each side of the axis of rotation.

In embodiments, the photodiode is preferably aligned on the axis of rotation.

In embodiments, the connector portion can comprise an optical element deflecting the laser beam toward the active surface of a photodiode.

In embodiments of the connector portion, a mounting plane of the photodiode and of the laser of said connector portion is inclined while maintaining the center of the active surface of the photodiode on the axis of rotation of the connector.

In embodiments, the laser is preferably aligned on the axis of rotation of the connector.

In embodiments, the photodiode is preferably oriented by approximately 90° relative to the axis of rotation and the portion comprises a filter for deflecting a laser beam received on the photodiode.

In embodiments, the connector portion comprises a lens and/or a diaphragm, for example.

In embodiments, the connector portion comprises an electronic portion intended to convert an electrical signal into an optical signal, and vice versa.

In embodiments, the connector portion preferably comprises electrical contacts for an electrical transmission.

In embodiments, the connector portion preferably comprises means for facilitating the relative rotation between the socket and the plug.

In embodiments, the means for facilitating the rotation comprise a ball bearing system, for example.

In embodiments, the invention relates to a connector comprising a portion as described in the present application as a socket and/or as a plug.

In embodiments of the connector, the socket and the plug comprise means for the connection and the alignment thereof.

### BRIEF DESCRIPTION OF THE DRAWINGS

FIGS. 1 to 7 show embodiments of the optical means according to the present invention.

FIG. 8 shows an embodiment of the principle of a connector according to the present invention.

FIG. 9 shows an axial section view of an embodiment of a connector according to the present invention.

FIG. 10 shows an axial section view of a connector according to the present invention.

FIGS. 11 to 14 show embodiments of connector portions and of a connector according to the present invention.

FIGS. 15 and 16 show embodiments of connector portions and of a connector according to the present invention.

FIGS. 17 to 19 show embodiments of connector portions and of a connector according to the present invention.

FIG. 20 shows connector portions according to another embodiment of the invention.

### DETAILED DESCRIPTION

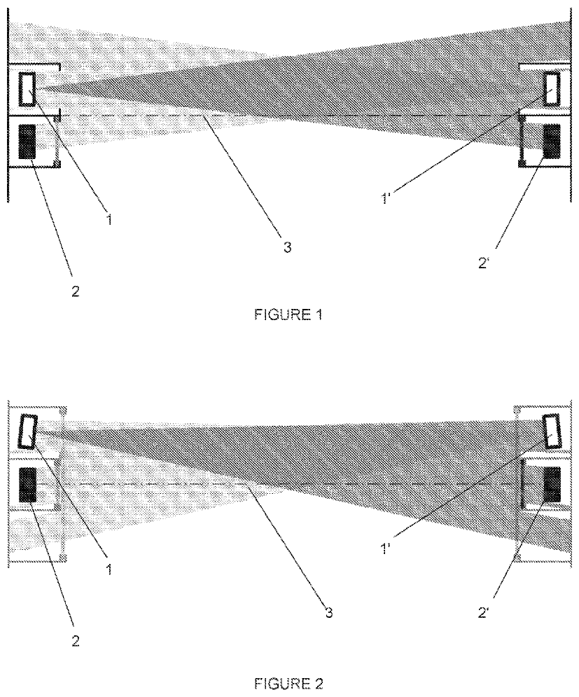

FIG. 1 shows a first embodiment with a laser 1, 1′ and a photodiode 2, 2′ on each side of the axis of rotation 3 of the connector.

This relatively simple to implement solution is characterized by the intensity of the received light being dependent on the rotation of the connector. Indeed, in one position, the photodiode 2, 2′ is located at the center of the beam of the laser 1, 1′, where the light intensity is greatest, whereas when rotated by 180° (as shown in FIG. 1) the photodiode 2, 2′ is located at a certain distance from the center of the laser beam 1, 1′ and for this reason the received light intensity is reduced. In some cases, this can be considered to be disadvantageous. In other cases, this is not a problem and this construction is perfectly acceptable.

FIG. 2 shows another embodiment with the lasers 1, 1′ and the photodiodes 2, 2′. In this embodiment, the photodiodes 2, 2′ are placed on the axis of rotation of the connector and the center of the laser beam 1, 1′ reaches the photodiode 2 or 2′ of the other portion of the connector. The advantage of this concept is that the center of the laser beam is constantly on the photodiode, irrespective of the relative rotation of the connector portions. In return, the axis of the laser is not parallel to the axis of rotation of the connector.

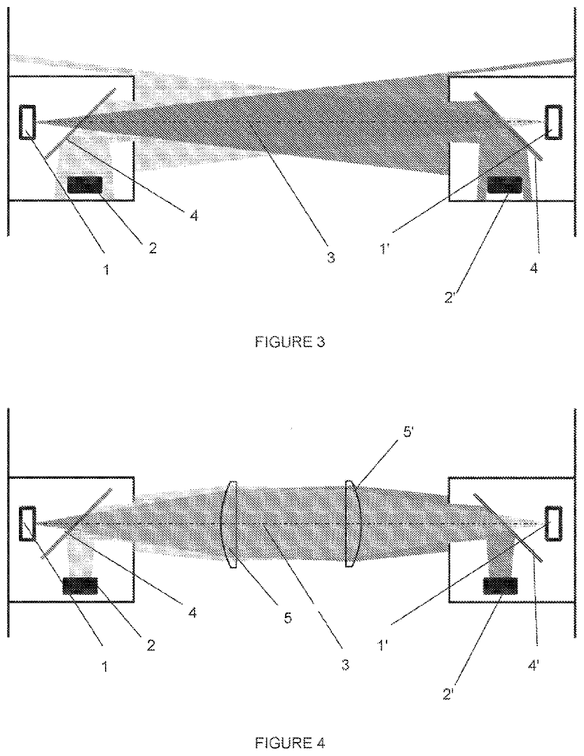

FIG. 3 shows another embodiment with the lasers 1, 1′ in the axis of rotation of the connector and the photodiode 2, 2′ oriented at 90° with a dichroic filter 4, 4′ allowing the laser beam to deflect on the photodiodes 2, 2′. This solution has the same advantage as the previous solution, i.e., the center of the laser beam always reaches the photodiode, irrespective of the relative rotation of the connector portions. Furthermore, the angle of arrival of the laser beam on the photodiode also remains the same during the rotation.

These embodiments can be improved by adding lenses, as described hereafter.

Lens at the Exit of the Laser

Focusing the exit of the laser with a lens has the same effect as bringing the laser closer to the photodiode in terms of the received light intensity as a function of the lateral movement. The mechanical constraints do not always allow the photodiode to draw close enough to the laser, adding the lens at the exit of the laser allows this distance to be compensated.

In the case of the second embodiment, where the laser beam is not parallel to the axis of rotation of the connector, using a lens at the exit of the laser allowing the photodiode to be spaced apart from the laser allows the angle between the axis of rotation and the laser beam to be reduced, which can be an advantage in several respects, such as:
the difference in the angle of arrival of the laser beam on the photodiode is lower during the rotation of the connector. For this reason, it is easier to focus the beam on the active surface of the photodiode with a lens in front of said photodiode;
a pane can be provided between the two connectors that provides the seal for each portion, the more the laser beam exits perpendicular to the pane, the lower the deflection of the beam due to water (for example).

Lens in Front of the Photodiode

The photodiode allows the light intensity received by the photodiode to be increased even when it moves away from the center of the laser beam.

As the active surface of the photodiodes allowing communication at the contemplated speeds is very small (˜ø60 um), adding a lens is preferable for increasing the received light intensity. If the center of the laser beam is the same as the axis of rotation of the connector (as in the case of the BOSA), the angle of arrival of the laser beam on the photodiode does not vary with the rotation of the connector and a standard plano-convex or bi-convex optic is preferred. Furthermore, it also corrects a lateral offset between the two connector portions by causing the light beam to arrive at a significantly more pronounced angle (which can make placing the lens in series problematic). However, it can make the system more sensitive to the angular offset.

Lens at the Interface of the Connectors

Since the rotating connector must be a connector that can be used outside, it is possible for water to settle on the interface of the connector where the laser beam passes. In order to limit the deflection of the beam, it is preferable that this interface is made as narrow as possible so that the water cannot form droplets with a “spherical” surface and it is also preferable for the beam to exit as perpendicular as possible so that there is no deflection as a function of the refractive index of the medium (water or air). A proposal for a BOSA system with plano-convex lenses at the interface is shown in FIG. 4, which shows an embodiment with lenses 5, 5′ for concentrating or focusing the beam on the construction of FIG. 3.

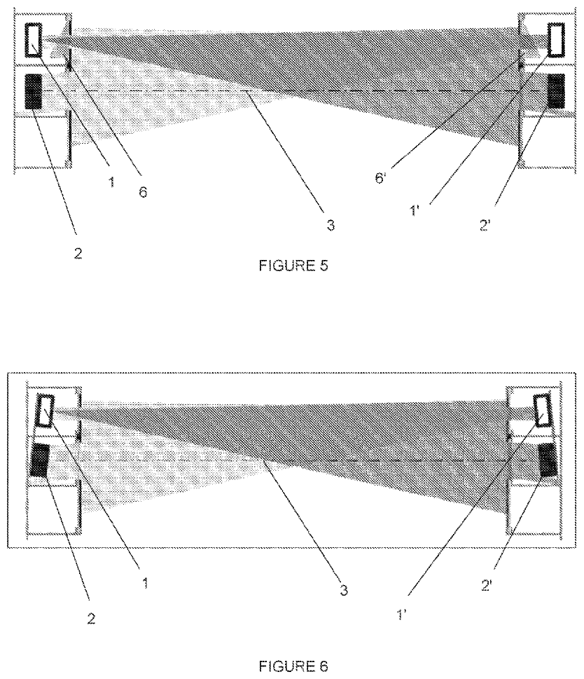

In another embodiment, the laser beam can be inclined relative to the axis of rotation of the connector so that the sensor thereof is on the active surface of the photodiode 2, 2′. If the intention is to keep the photodiode 2, 2′ and the laser 1, 1′ in order to facilitate assembly, two embodiments are described: the first involves deflecting the beam using an optical element 6, 6′ shown in FIG. 5. This element can be a lens or a prism, for example, or another equivalent means.

The advantage of this solution involves having the mounting plane of the laser 1, 1′ and of the photodiode 2, 2′ perpendicular to the axis of rotation of the connector; however, it requires an additional optical element 6, 6′.

The second solution shown in FIG. 6 involves inclining the entire mounting plane of the photodiode 2, 2′ and of the laser 1, 1′, while maintaining the center of the active surface of the photodiode on the axis of rotation of the connector.

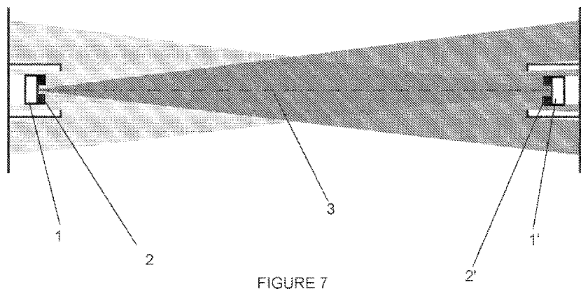

Another embodiment is schematically shown in FIG. 7. In this embodiment, a monolithic system is used that comprises a diode and a photodetector. Such a system is marketed by Broadcom under the name “AFBR-FS50B00 Transceiver for Optical Wireless Communications”. These transceivers are described, for example, in the publication entitled “Monolithic VCSEL-PIN Photodiode Integration for Bidirectional Optical Data Transmission” by Alexander Kern et al, IEEE Journal of Selected Topics in Quantum Electronics, Vol. 19, No. 4, July/August 2013. In summary, this system uses the principle of stacking transmitter 1, 1′ and receiver 2, 2′ elements.

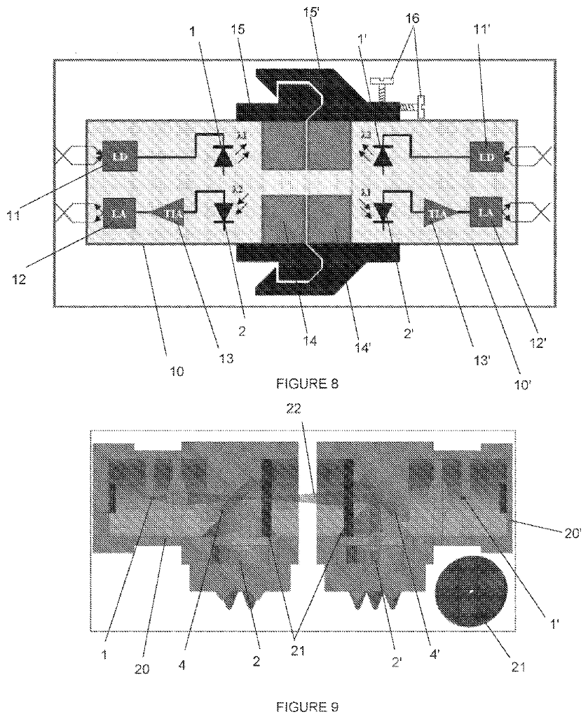

FIG. 8 shows the principle of one embodiment of the invention. The system comprises an electronic portion 10 in each element of the connector (plug and socket) that converts the differential electrical signal into an optical signal, and vice versa. The electronic portion 10 particularly comprises laser diodes 1, 1′, the photodiodes 2, 2′, the drivers 11, 11′ for the laser, the limiting amplifiers 12, 12′ and the amplifiers 13, 13′, an optical portion 14, 14′ allowing the passage of light and limiting any reflections, and the system comprises a mechanical portion 15, 15′ allowing the connection and the alignment (lateral movements, spacing, rotation) between the two elements 15, 15′ by the alignment means 16.

FIG. 9 shows a specific implementation of an embodiment with the previously identified and discussed reference signs. Reference 20/20′ identifies the portion particularly containing the optical means 1, 1′, 2, 2′, 4, 4′, for example, a “BOSA” type element. In this embodiment, a diaphragm 21 is preferably added in order to minimize any disruptions in the beam 22 of the laser 1. The diaphragm has, for example, an aperture with a diameter approximately ranging between 0.1 mm and 1 mm.

In this embodiment, each of the two connector portions comprises a “BOSA” type element comprising a transmitter 1, 1′ (for example, a laser), a receiver 2, 2′ (for example, a photodiode), as well as other electronic and optical elements, as shown in FIGS. 7 and 8. The “BOSA” type elements allow the transmitted and received signals to be on the same optical axis. This element is modified in order to be able to be used for contactless transmissions. A PCB 10, 10′, as well as a lens 5, 5′ (for example, at the exit of the BOSA, as shown in FIG. 4), are particularly added to said element. The PCB 10, 10′ is shown partially outside the connector portions, but this illustration is a non-limiting example and it also can be fully integrated and/or contained in the relevant portion in all the embodiments of the invention.

Furthermore, the diaphragm 21 can be added in order to avoid any reflections and to allow speeds of the order of 10 Gbit/s or more to be achieved in accordance with the speeds produced within the scope of the present invention.

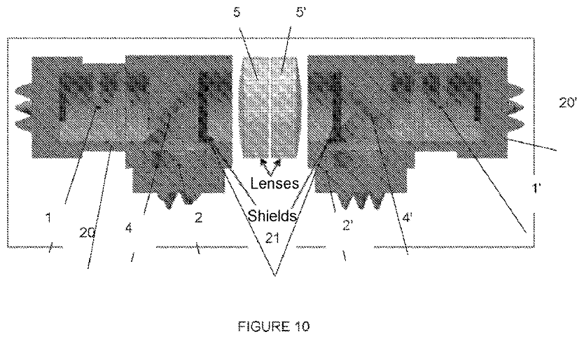

FIG. 10 shows an embodiment of the system of FIG. 9 with lenses 5, 5′. These lenses can be used in all the embodiments.

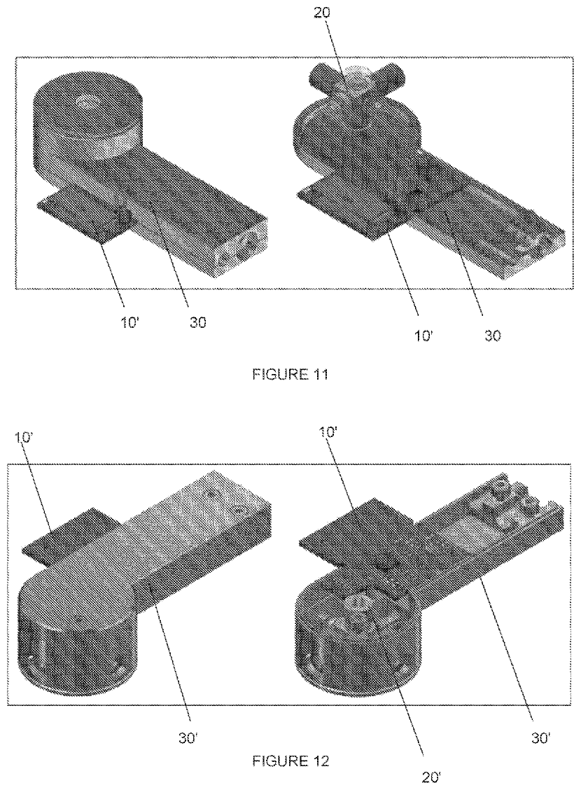

FIGS. 11 to 14 show embodiments of a connector portion or of a connector according to the invention as various views and cross sections.

FIG. 11 (left-hand drawing) shows a perspective view of such a male or female connector portion 30 (plug or socket). FIG. 11 (right-hand drawing) shows the portion 30 open. The “optical” construction selected as an illustrative example of this embodiment can correspond to that of FIG. 4 or 9 described above.

FIG. 12 (left-hand drawing) shows a perspective view of such a male or female connector portion 30′ (plug or socket). FIG. 12 (right-hand drawing) shows the portion 30′ open. The “optical” construction selected as an illustrative example of this embodiment can correspond to that of FIG. 4 or 9 described above.

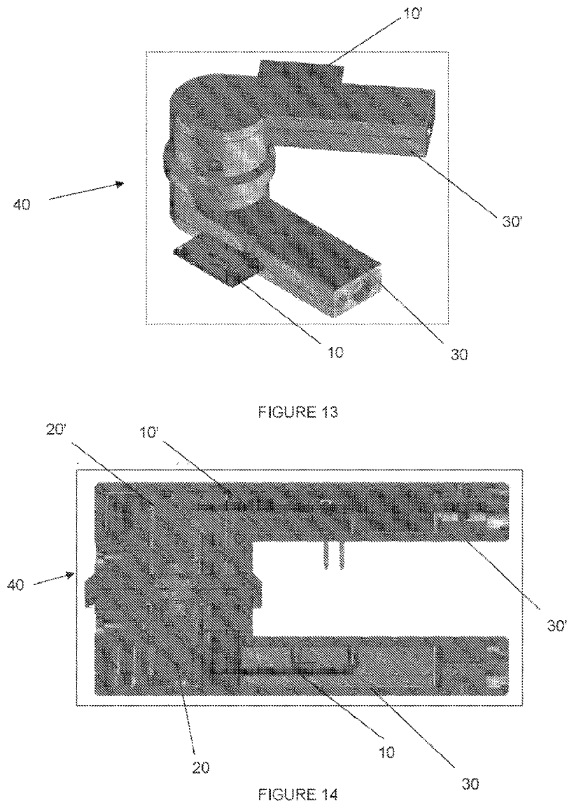

FIG. 13 shows a perspective view of an assembled connector 40 comprising a portion 30 and a portion 30′, for example, according to FIGS. 10 and 11.

FIG. 14 shows a section view of the connector of FIG. 13.

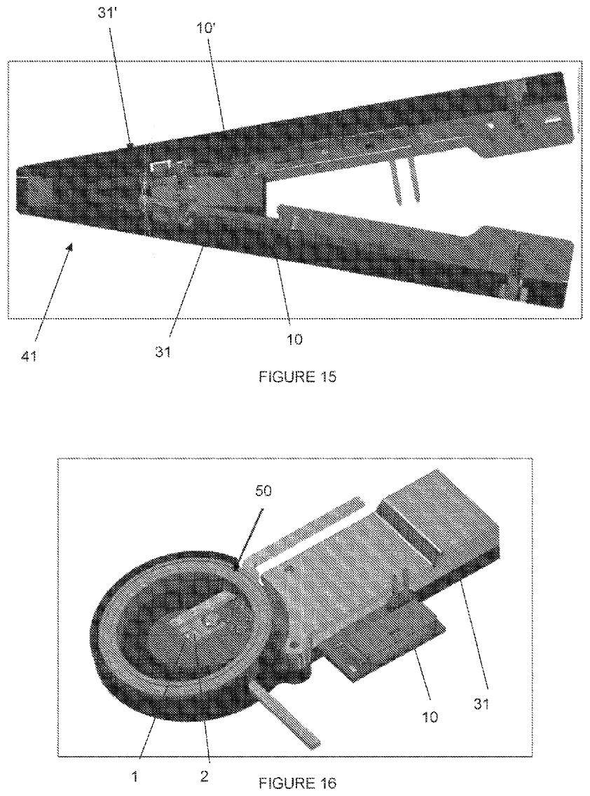

FIGS. 15 and 16 show embodiments using the optical system of FIG. 6, in which the laser 1, 1′ and the diode 2, 2′ are inclined relative to each other.

This embodiment preferably integrates the same elements as the previous embodiment (FIGS. 11 to 14). In this embodiment, the laser 1, 1′ is offset from the axis of rotation of the connector 41, as in FIG. 6, so as to optimize the transmission of the signal in all the positions over an arc of 360°. The transmitted and received signals pass through separate optical axes and a lens is advantageously used in this case. This embodiment also allows performance capabilities to be achieved that range up to 10 Gbit/s or more in accordance with the performance capabilities produced within the scope of the present invention.

The plug and the socket (male and female portions) are referenced 31, 31′, the assembled connector 41 and the electronic portions (PCB) 10 and 10′. The transmitter 1 (laser) and the receiver 2 (photodiode) are shown in FIG. 16, as well as a ball bearing type means 50 for facilitating the relative rotation of the two connector portions.

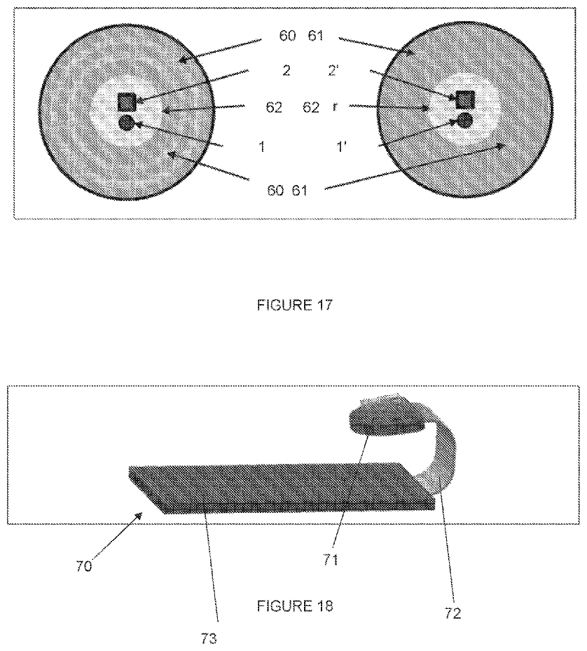

The principles of the present invention can be applied to an electrical connector for forming a hybrid electrical and optical construction. An example of such an electrical connector, to which said principles can be applied, is described in publications WO 2017/072620, WO 2019/193564 and WO 2019/193567 (incorporated in the present application for reference purposes) and the principle is shown in FIG. 17 with the tracks 60 and the contacts 61 and light diffusers 62.

The benefit of this construction involves integrating a power transmission by electrical means. In this embodiment, a “Rigid-Flex” printed circuit is used, for example, that allows the laser and photodiode portion of the printed circuit to be offset and the electrical signals to be transmitted through a flex 72 to the transceiver 73.

FIG. 18 shows this printed circuit 70, with the offset laser/photodiode portion 71 and the flex 72.

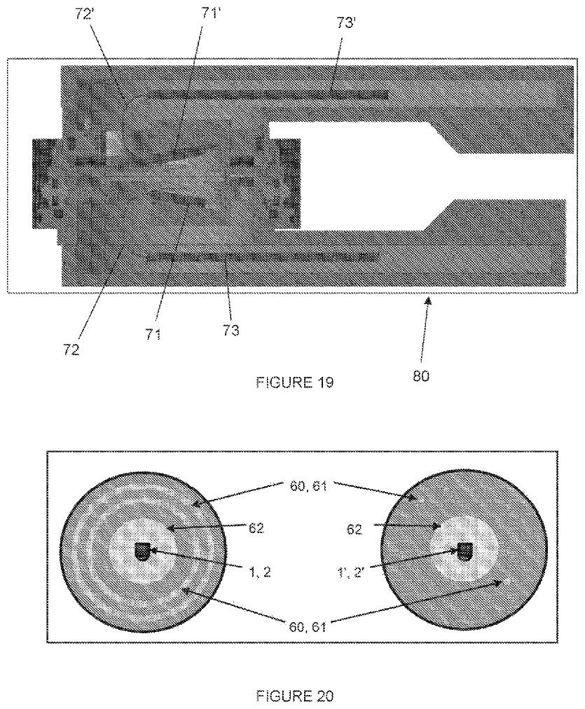

FIG. 19 shows a connector 80 according to this embodiment with a printed circuit 70/70′, an offset laser/photodiode portion 71, 71′, a flex 72/72′, a transceiver 73/73′ and the configuration of the optical means is in accordance with FIGS. 6, 14 and 15, for example.

FIG. 20 shows an embodiment of a construction using the monolithic system comprising the diode 1, 1′ and photodetector 2, 2′ assembly of FIG. 7 and in a connector, the principle of which is shown in FIG. 17. Such a construction of FIG. 20 can be used, for example, in the connectors of the aforementioned publications WO 2017/072620, WO 2019/193564 and WO 2019/193567 within the scope of the description of FIG. 17.

The embodiments described have been described by way of illustrative examples and must not be considered to be limiting. Other embodiments can use means equivalent to those described, for example. The embodiments also can be combined together as a function of the circumstances, or the means used in one embodiment (for example, as shown in a figure) can be used in another embodiment (for example, as shown in another figure). Furthermore, the forms and assemblies of the various portions shown in the drawings are provided by way of illustrative and non-limiting examples.

1-14. (canceled)

15. A connector component configured to be removably connected to another connector component, the connector component configured to rotate relative to the another connector component around an axis of rotation when the connector component is connected to the another connector component, the connector component comprising:
an optical communication device configured for optical data transmission, the optical communication device configured to permit the optical data transmission to the another connector component irrespective of an angle of orientation between the connector component and the another connector component about the axis of rotation,
wherein the optical communication device includes a laser that is configured to emit an outgoing light beam and a photodiode configured to receive an incoming light beam, and
wherein the laser or the photodiode is arranged to be offset from the axis of rotation.

16. The connector component of claim 15, wherein the laser and the photodiode are both arranged to be offset from the axis of rotation.

17. The connector component of claim 15, wherein the photodiode is arranged at the axis of rotation of the connector component.

18. The connector component of claim 15, wherein the optical communication device further includes an optical element that is configured to reflect the incoming light beam to the photodiode.

19. The connector component of claim 15, wherein the optical communication device is arranged at an oblique angle relative to the axis of rotation and an active surface of the photodiode is arranged to lie within the axis of rotation of the connector component.

20. The connector component of claim 15, wherein the laser is arranged at the axis of rotation of the connector component.

21. The connector component of claim 15, wherein an active surface of the photodiode is arranged to be substantially parallel to the axis of rotation of the connector component, and the optical communication device including a filter to redirect at least a portion of the incoming light beam to the photodiode.

22. The connector component of claim 15, wherein the optical communication device includes at least one lens and a pinhole arranged in an optical axis of the outgoing light beam.

23. The connector component of claim 15, wherein the optical communication device includes a data communication transceiver.

24. The connector component of claim 15, further comprising:
one or more electric contacts for electric interconnection with corresponding electric contacts of the another connector component.

25. The connector component of claim 15, further comprising:
a device for facilitating a rotation of the connector component relative to the another connector component when interconnected with each other.

26. The connector component of claim 15 forming a base or a plug of a connector system.

27. A connector system including first and second connector components that are configured to be removably connected to each other and rotate relative to the each other around an axis of rotation when connected to each other, each one of the first and second connector components comprising:
an optical communication device configured for optical data transmission, the optical communication device including a laser that is configured to emit an outgoing light beam and a photodiode configured to receive an incoming light beam,
the optical communication device configured to permit the optical data transmission to between the first and second connector components irrespective of an angle of orientation between the first and second connector components about the axis of rotation,
wherein the laser or the photodiode is arranged to be offset from the axis of rotation.

28. The connector system of claim 27, wherein at least one of the first and second connector components include:
a device for facilitating a rotation of the first and second connector components relative to each other when interconnected with each other.

29. The connector system of claim 27, wherein the first and second connector components include:
one or more electric contacts for electric interconnection with corresponding electric contacts of the first or second connector component, respectively.

30. The connector system of claim 27, wherein the optical communication device of the first and second connector components is arranged at an oblique angle relative to the axis of rotation and an active surface of the photodiode is arranged to lie within the axis of rotation of the first or second connector component, respectively.

31. The connector system of claim 27, wherein the first and second connector components are configured to rotate about 360 degrees with respect to each other.

32. The connector system of claim 27, wherein the photodiode of the optical communication device of the first and second connector components is arranged at the axis of rotation of the first or second connector component, respectively.

33. The connector system of claim 27, wherein the optical communication device of the first and second connector components further includes an optical element that is configured to reflect the incoming light beam to the photodiode.
